(19) United States
(12) Patent Application Publication
(10) Pub. No.: US 2011/0307779 A1
(43) Pub. Date: Dec. 15, 2011

(54) SYSTEM OF RETAINING, MANAGING AND INTERACTIVELY CONVEYING KNOWLEDGE AND INSTRUCTIONAL CONTENT

(76) Inventors: Gordon Scott Scholler, Poway, CA (US); Zahi Itzhak Shirizli, Rishon le Zion (IL); Ronen Zeev Levy, Tel-Aviv (IL)

(21) Appl. No.: 12/814,844

(22) Filed: Jun. 14, 2010

(51) Int. Cl. G06F 3/01

(52) U.S. Cl. 715/705; 715/716

(57) ABSTRACT

An instructive content creation and viewing system, including a first microprocessor assembly, an intuitive viewing interface, a second microprocessor assembly in communication with the first microprocessor assembly, and an content creation interface. The viewing interface is housed on the first microprocessor assembly and the content creation interface is housed on the second microprocessor assembly. The content creation interface is used to create the instructive content, while the first microprocessor assembly obtains the instructive content. The viewing interface presents the instructive content while the viewing interface adapts to the instructive content and user preferences or actions.

### TECHNICAL FIELD

The claimed technology relates generally to the exchange of information. More specifically, the presented novel technology relates to systems and methods in which author produces informative content as the subject matter expert or on behalf of a subject matter expert for use in knowledge transfer with one or more potentially non-collocated users.

### BACKGROUND

Before computers were invented, teaching and instruction were accomplished primarily through one of two means, namely personal instruction and written learning materials. Either means has been found to be inadequate under certain conditions. Personal instruction suffers from the drawback that knowledge transfer only occurs where and when the instructor is present. Furthermore, a live instructor is less likely to provide the repetition often required to promote greater retention of the material covered. On the other hand, while written instruction provides for repetition it is often ineffective for conveying complex and troublesome materials.

However, on the whole it is widely held that under normal conditions a live instructor utilizing appropriate supplementary media represents the most effective means of teaching. The concept that media-supplemented live instruction is superior over non-live instruction was pioneered by Soviet psychologist Lev Vygotsky. Named the Zone of Proximal Development (hereafter ZPD) by Dr. Vygotsky, this idea represents the difference between what a learner can learn without help and what he or she can learn with help. Building upon the ZPD, scaffolding represents the tapering off of instructor assistance as the learner gains greater understanding of the subject material and, hence, requires less instruction. Matching the degree of instruction to the learner's readiness level is another way to view scaffolding.

Differentiated instruction builds upon scaffolding. Learners usually vary in aptitude and ability from one and another because of their individual differences in education, experience, skill, and the like. Differentiated instruction seeks to bridge these differences through placing the learner at the center of the teaching process. That is, differentiated instruction proactively aims the instructive process at the learner through targeting the learner's interest, unique differences, prior level of understanding, and the like, while dynamically adjusting this aim as the learner gains competence.

All attempts to involve computers to facilitate knowledge retention, knowledge management, and knowledge transfer has been plagued by various shortcomings. The use of computers for knowledge retention, knowledge management, and knowledge transfer has failed to incorporate the lesson from ZPD that an instructor makes a difference. Additionally, previous attempts at computerized instruction have failed to incorporate scaffolding and the differentiation of instructions. These shortcomings result in computer aided knowledge actions being limited to linear instruction, non-adaptive and non-interactive content, mono-directional interaction, the inability of a user or author to separate their activity from the computer mechanism, non-user directed content development, and the inability to provide user-requested specific assistance.

Learning is often a non-linear, and even dynamic, process. When teaching effectively, a human instructor provides for more than just a linear presentation of instructive material—a human instructor can adjust her teaching approach ‘on-the-fly’. A human instructor also provides answers and insights to tangential material, more in depth answers and understanding when requested, and presents the subject in an order at least partially dictated by the student. Further, a human tutor encourages note taking, facilitates review of the material presented, and provides a means of interaction intended to resolve unpredicted instructional requests. Moreover, a human tutor will naturally try to make use of mixed means of conveying the information whenever possible.

A common example of non-linear learning is learning ‘on the job’ or ‘in the field’. Such learning is characterized by a more experienced co-worker assisting a less skilled co-worker through problems of varying difficulty, complexity, and required know-how. The problems are not ordered in any way other than the order of their occurrence on the job or in the field. It is the more experienced co-worker's ability to jump to the knowledge needed while providing the background, tangential, and in-depth knowledge as required to make learning on the job viable. Prior computer knowledge transfer systems, with their largely preordained content, are simply unable to adequately address the unpredictable learning needs of ‘on the job’ learning.

For the most part, a human instruction is an ‘easy to learn from’ interaction. Live human instructors provide an intuitive and context sensitive environment from which to learn. For example, a live human instructor will easily understand non-verbal feedback, such as raised eyebrows indicating the need for further explanation in one context while indicating comprehension in another. The raised eyebrow is effectively the same interface action but with a context sensitive meaning that both the student and instructor understanding.

However, the scenario is very different with existing computer knowledge transfer systems. The interfaces of such systems are not context sensitive but rather task specific. This creates the situation where the student is forced to learn the system's interface, spending considerable concentration upon the use of that interface while trying to learn the material. As would be expected, as the number of user choices and actions required at the user interface increases so does the complexity of learning from that computer aided instructional system. This is because the student is forced to acquire the necessary competency with the system's interface at the same time that he is attempting to learn the material. It is not hard to understand that this required mastering of the interface, while simultaneously trying to master the material, greatly increases the total effort required. Further, as if this additional complexity wasn't bad enough, incorrect actions while using the user interface often lead to unexpected and frustrating results for the student. Indeed, if any learning is occurring at this time, it likely includes the learning to dread computer aided knowledge transfer systems and methods.

A similar problem is experienced by the author when trying to create the instructive content. In this case, it is the complexity of organizing and effectively presenting material that is compounded as the number of author choices and actions required to create instructive content increases. It is unfortunate that the instructor must often acquire the technological competency in the use of the content creation tool while at the same time trying to organize and put together instructional content with the creation tool. Inexpert authorship of the subject matter is especially problematic, since the student, already having to suffer from the complexity of the user interface, is now likely forced to try to learn from a less than optimally structured lesson.

Finally, live human instructors generally encourage some form of note taking and interaction. The interaction can be as little as the student indicating comprehension to as great as role reversal, with questions and answer sessions falling somewhere in the middle of this range. Note that interaction also provides for later answers to new and previously unforeseen questions or misunderstandings. This interaction also provides a means by which to obtain feedback with which to improve future knowledge transfer sessions.

However, the interaction envisioned by prior computer aided instructional systems is typically “one-way,” such that instructional content is delivered to an individual during a specific time. As such, prior computer knowledge transfer systems generally lack any mechanism providing for interactions with the author or means of replying to an instructional need at a later time. Additionally, prior computer knowledge and transfer systems generally do not provide for any built-in means of note taking Prior computer knowledge or transfer systems also generally lack a refined and automatic means of feedback. As such, the concept of continually improving the content for the management, transfer, or retention of knowledge is generally foreign to prior computer knowledge management or transfer systems.

Therefore, there is a need to provide an improved computer aided instructional solution that permits efficient construction and delivery of instructive content while affording participants a more naturally and intuitively interface, while permitting non-linear ordering of the instructive content and a means of note-taking and various means of interaction. The present novel technology addresses this need.

### SUMMARY

The novel technology is set forth in the claims below, and the following is not in any way to limit, define, or otherwise establish the scope of legal protection. In general terms, the novel technology relates to an improved system and method of providing computer aided instruction that allows participants to more naturally learn and interact as though they were being taught by a human instructor.

One object of the novel technology is to provide an improved computer-assisted knowledge transfer and management system. Further objects, embodiments, forms, benefits, aspects, features, and advantages of the claimed technology may be obtained from the description, drawings, and claims provided herein.

### BRIEF DESCRIPTION OF THE DRAWINGS

FIG. 1 is an illustrated overview of one example of a knowledge transfer system according to the claimed technology.

FIG. 2 illustrates an exemplary display screen of content creation interface according to the example of FIG. 1.

FIG. 3 illustrates a second exemplary display screen of content creation interface according to the example of FIG. 1.

FIG. 4 illustrates an exemplary display screen of instructive content viewing interface according to the example of FIG. 1.

FIG. 5 illustrates an exemplary of an interactive panel for interaction with a user.

FIG. 6 illustrates an exemplary process flow for one implementation that includes publishing the instructive content.

### DETAILED DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

The following definitions are provided for convenience. User: a person who desires to acquire information, instruction, and/or understanding. Examples include students, customers, product owners, product testers, and the like. Instructor: a person who wishes to convey information, instruction, and/or understanding to a user. Examples include teachers, trainers, marketers, hobby enthusiast, managers, and the like. Subject matter expert (SME): a person recognized as being able to demonstrate a relatively high degree of mastery over a subject, information, and/or understanding and who is able to convey that understanding to others. Examples include professors, highly skilled employees, noted artists, teaching enabled experts, and the like. Author or authors: a person or group of people who create, edit, add to, refine, or enhance instructive content. An author may or may not be a SME. A delivery device: is a multimedia enabled electronic device that provides for user interaction. Examples include smart phones, personal computers, personal digital assistants, interactive kiosks, and the like. Multimedia: an image, audio clip, video clip, audio video clip, an application, an attachment, a selectable universal resource location, and the like. Examples include image files, selectable web links, application links, film clips, word processor files, and the like.

The present novel technology provides a system and method for the management of knowledge along with the transfer of knowledge through the construction, refinement, and control of instructional content. The instructional content is constructed in such a way as to permit authors to produce instructive and multimedia rich content that is potentially non-linearly and even dynamically directed in its presentation. The present novel technology also provides a system and method for the user to augment the instructional content, offer criticism for improvement of the instructional content, and to request additional assistance when needed. It is worth noting that requested assistance is unique to the user in that the request includes user-instructional content-specific interactions leading up to the request.

Further, the present novel technology provides a means for the author to implement role-based security over the production of the instructional content. This in turn permits the author to employ a team of individuals during the creation process, each team member having limited and role specific abilities. For example, a multi-media specialist could be employed to incorporate the various media. However, the multi-media specialist typically would not have the ability to alter the narrative of any instruction.

Somewhat similar to role-based security over production of the instructive content is this novel technology's source control implemented through the act of publication. Instructional content is not viewable upon a viewing interface until it is published. Typically controlled though a single centralized entity, publishing adds encryption and an authenticity stamp to the instructional content. Thus, a user viewing instructional content can be sure that it is authorized and legitimate, free from malicious or accidently added content.

The present novel technology also provides a natural and intuitive indexing mechanism based upon the narrative content of an instruction. The narrative content of an instruction is the text representation of the speech component of that instruction. In one embodiment, there is purposefully no limit upon the number of different sets of narratives collectively associated with the instructive content. In some embodiments, each textual narrative is automatically converted into a text-to-speech audio file (also known as a text-to-speech audio segment). In other embodiments, if desired, the author or other creating entity with sufficient rights can replace the automatically created text-to-speech file 63 with a recorded speech narrative (also known as a recorded speech audio segment). Subtitles during viewing are made possible through the retention of the text based narrative and are enabled through user action at run time. Optionally, it is even possible to have subtitles in a language different than the spoken language.

Optionally, multilingual support is achieved by supplying the narrative, either spoken or as text, in the other languages. The content creation interface does the rest of the work with respect to synchronizing previously synchronized content to a newly supplied narrative. Typically, language used during viewing is a user selection.

The indexing mechanism is a relative timeline based on the speech file of the default language. Also known as storyboarding, this indexing mechanism of using the relative, based on the speech file timeline is then typically used to organize the various media associated with that instruction. Basing the indexing on the speech of the narrative provides a relative timeline with which to organize the media against that an author will quickly grasp. As an example, consider an instruction that has two images (pictures) associated with it and a narrative that requires seven seconds. This narrative provides only a total of seven seconds to be distributed among the presentation of the two images during that instruction.

Continuing with the example, the author could select that the first image be given three seconds of exposure while the second image receives the remainder of the time. The relative proportions of allocated time will remain constant regardless of the actual length of the speech file. For example, if the Japanese narrative requires fourteen seconds, the first image would receive three-sevenths ( 3/7) of that time or six seconds of presentation. The second image would receive the remaining eight seconds. There are, of course, more complex options such as: minimal or maximal presentation time; presentation to start after or before some event or time; conditional presentation; conditional sharing (among instructions) of presentation; and the like. It is this relative to the speech narrative used at viewing time that enables the seamless and easy to understand integration of multimedia and instructions. It should be noted that in addition to various timing relationships, the relative timeline for an instruction also includes various meta data information concerning the multimedia associated with the instruction. Furthermore, multimedia elements normally void of a temporal quality, such as a web link, are typically assigned a default nominal temporal value subject to change by the author. Also, subject to author control, the timeline defaults to a sufficient length where the instruction's narrative is insufficient for the presentation of all associated multimedia.

Additionally, the present novel technology provides a means for the author to anticipate and provide for the additional instructive needs a user might have. A section is a sub portion of the instructional content. A step is a collection of instructions mostly related to a common topic and best presented as a collective whole. An analogy would be that if instructions were sentences, then a step would be a paragraph while a section would be a passage.

Typically, at the end of a step a user will be able to take an action or respond according to his comprehension. Exemplary actions include, but are not limited to, opening an attachment or link, printing a document or portion of the instructive material, activating a timer or self evaluation quiz, skipping the next or several portions of the instructive material, or the like.

The responses based upon comprehension are normally limited to three different responses roughly corresponding to: comprehension; near comprehension; or virtually no comprehension. The responses can also to be thought of as a positive response from the use, a less than positive response from the user, and a negative response from the user. Optionally, these three responses are also respectively known as: “I understand,” “hint,” and “help.” In another example, operationally the three responses are known as, “I understand and want to proceed,” “I need a hint,” and “I do not understand, help me.” In yet another example, operationally the three responses are known as, “I'm happy,” “I'm satisfied,” “I'm dissatisfied.” In the case of comprehension, the user simply informs the viewing interface of his understanding and is usually advanced to the next applicable step. In the case of near comprehension or slight confusion, the user typically asks the interface for a hint. The user usually asks the viewing interface for help in the case of no or minimal comprehension.

Asking for a hint causes the interface to bring up the information the author has provided as a hint. Typically implemented as a single instruction, a hint includes the extra information that an author believes would be sufficient to cement a mostly understood concept or information. On the other hand, asking for help delivers far more substantial information. In this case, the extra information can have an implementation ranging from a step all the way up to a series of instructional contents. For example, a hint over the indexing of pointers in Java might be a single instruction stating that the pointer's value represents a memory location. Help over the same information could be an entire series of instructional contents over dynamically allocated memory structures and their manipulations.

The novel technology also provides for the event where the user continues to not understand after receiving all available help. In this case, the viewer permits the user to compose and send a message to the author or designated authority for that instructional content. As previously noted, this message usually includes the meta knowledge of the user's interactions with the instructional content. For example, the meta knowledge will include the path of steps and actions taken with respect to the instructional content in question. In practice, this helps to contextually frame any misunderstanding the user may be experiencing.

The novel technology also provides for the user to guide the presentation of the instructional content. Usually, every instructional content has a device similar to a table of contents listing the structure of the informative content. Typically, the listing of the structure will show the instructional content as be composed of chapters, sections, and steps. The viewing interface permits the user to start at any chapter, step, or where the user last left off from. However, in addition to the table of contents mechanism, the viewing interface permits the user to fast forward or even prematurely end any step he is viewing and skip to or choose any other portion of the instructional content. An illustrative example would be skipping over the Mac instructions for software that has just installed on a PC.

Typically, instructional content may also contain interactive panels. An interactive panel can be thought of as a small application capable of performing a wide variety of functions. For example, one form of the interactive panel enables the author to form a collection of instructive topics (steps and other instructional contents). The idea of this usage of the interactive panel is to permit the user to choose the order and one at a time, the number of instructional topics the user wishes to view.

Search is another means by which the user can select the instructional topics of the instructive content he wishes to view in another example. To search, the user enters in the search criteria and performs a search. The instructional topics return are typically those that match the search criteria. For example, the user could enter in key words and perform a search. The instructional topics returned would be those that most closely matched the key words.

Another exemplary use of the interactive panel is to collect information. The interactive panel can then disseminate the information or perform various functions based upon the information. Dissemination of the information can be immediate or at some later time. Dissemination can be to the user or to some other entity such as a test score repository. Note that dissemination of information can also take other forms such as sending progress reports of the user's progress over the instructive material.

Sequencing the presentation of the instructive content based upon user supplied information would be an example of the use of an interactive panel. Another use of an interactive panel is for preliminary, post, or periodic testing of a user. Usage of the interactive panel before the user views the instructional content permits the user to skip over the portion of the instructional content that has already been mastered. Similar to a quiz, usage of the interactive panel at the conclusion of the instructional content permits evaluation of the user's comprehension of the material. Additionally, the interactive panel can also construct a review over that portion of the instructional content that was poorly understood. Finally, an interactive panel can be periodically used to ensure that a user comprehends the instructional content as he is viewing it.

Another use of the interactive panel is to use it as a means to help a technician diagnose and resolve an issue in the field. For example; a technician is out on a service call and has instructional content specifically for the machine to be serviced. He examines the machine and obtains some readings, measurements, error codes, or the like. He puts the readings into an interactive panel. From the readings, the interactive panel guides the presentation of the instructional content to the most pertinent chapters.

This novel technology also enhances the likelihood that a first use or viewing of instructive content will be a successful use or viewing. As previously stated, the novel technology provides a means for the author or SME to anticipate and provide for the additional instructive needs a user might have. As such, an author or SME can anticipate where a user might experience problems and provide additional and corrective instruction. Additionally, the author or SME can also go as far as to provide interactive panels requiring user input. This input could then be used to help sequence steps intended to help to prevent the user from experiencing problems. An example of this would be providing instructive content for a first time field technician. In this example, the author or SME is able to provide additional help and hints intended to enhance the likelihood of a successful outcome. Additionally, the author or SME could also provide multiple interactive panels as a means to implement double and triple checking of the technician's work, The double and triple checking interactive panels could also lead to corrective measures in the event where user supplied input indicates an issue.

The novel technology also helps to promote superior instructive content through the providing for the use of the best practices of: a) separation of work; b) a creation process ranging from linear to author oriented sequences; c) organization of content into digestible segments requiring user confirmation of comprehension; d) providing for user-on-demand additional helpful content; e) scaffolding and differentiation of instruction; and f) the user controlled presentation of the material. As previously stated, the content creation interface provides for the implementation of role based security. This in turn permits multiple parties to collaborate in content creation while limiting any participant's contribution to a previously defined role or activity. In this way, a separation of work can be imposed upon content creation. Furthermore, no specific sequence of creation events is imposed upon the development of instructive content. While it seems rational to develop instructive content first by fully developing the instructive narrative, no such limitation is imposed upon an author. Optionally, the author can work on virtually any instructive content development step at any time during the development process.

As previously stated, a step is a series of related instructions that requires a user response after viewing. The requirement of a user response after viewing a step serves to encourage the user to pay attention and provides areas for the user to obtain hints and help over the material. However, this requirement of a user response after a step also forces the author to organize the instructive content. The content is organized around where a user should respond, where a user might need a hint or might require help. The requirement of a user response after a step in turn provides for the instructive content to be broken up into digestible segments accompanied with optional assistance. Likewise, scaffolding, differentiation, and user controlled presentation provides similar incentive for the author to structure content into digestible segments.

The novel technology also provides for the user to augment his copy of the instructional content. The viewing interface permits the user to add comments to his version of the instructive content. Comments can be of the form of audio, text, speech to text, audiovisual, or the like. Additionally, the augmentation can be shared with others. Sharing can be automatic or filtered and controlled. Optionally, automatic sharing can be set by the author for the instructive content. Automatic sharing most often distributes users' augmentations amongst each other. Filtered and controlled most often occurs when a user chooses to send his augmentations to the author, usually for the purpose of improving the instructive content.

The novel technology also provides for feedback enabling the author to continually improve the instructive content. One way feedback is obtained is through the user answering an evaluating questionnaire. A questionnaire is typically added to the end of the instructive content and can either be the standardized default questionnaire or an author created questionnaire. In one embodiment of this novel technology, the feedback is sent to the author. In another embodiment of this novel technology, the feedback is sent to some previously designated entity such as a publishing editor, an author, a secondary author, a content reviewer, a corrections person, and the like.

This novel technology also provides for a robust and dynamic means of viewing the instructive content. The viewing interface typically consists of three buttons (I understand or go on, hint, help) along with the presentation control buttons (fast forward, pause, rewind, slow, etc.). Interface buttons are grayed out or deactivated when their prescribed behavior is inappropriate. Additional response buttons are also possible such as: open attachment, print, launch (application), start timer, open link, and the like. Additional response buttons are presented only when the associated, specific user interaction is permitted. This is to say that the additional buttons are only present when their associated behavior is appropriate. Typically, the previously discussed meta data contains information concerning the viewing interfaces controls and buttons.

A benefit related to the robust and dynamic viewing interface is that this novel technology provides for auto play. The viewing interfaces' controls are virtually universally understood and are only active when it makes sense for them to function. As such, there is almost no learning required to view the instructive material. This in turn provides for the use of the viewing interface, automatically showing instructive content, in a host of scenarios where having instructive content automatically conveyed to a user would be beneficial. An example of such a scenario would be where the user gets a new audio visual enabled device, such as a new laptop.

Optionally, the novel technology also provides for hands free viewing of the instructive content. One possible use of hands free operation is for the delivery of instructive content to special needs users. Another hands free use is the situation where a user is receiving instruction while performing a task that requires both hands. An example of this situation would be where the user is receiving instructive content over the repair of some machinery while performing the repair. The hands-free viewing is accomplished through the viewing interface, accepting voice commands as input. In one example, the viewing interface facilitates the presentation of instructive content to users having visual, hearing, or other sensory or learning impairments.

In that same example, the viewing interface is also able to accept other forms of user input enabling those with visual, hearing, or other sensory or learning impairments to utilize this novel technology. Interaction with those with learning or sensory impairments is typically achieved either through native capabilities within the viewing interface or through digital input/output interfaces. In one example, the technology has the capacity for presenting subtitles along with the auditory representation of the narrative. In another example, the technology also has the ability to accept voice commands as user input.

Furthermore, a digital input/output interface enables the viewing interface to present the instructive content on devices serving those with physical or learning impairments. Examples of such devices include Braille keyboards, Braille displays, and the like.

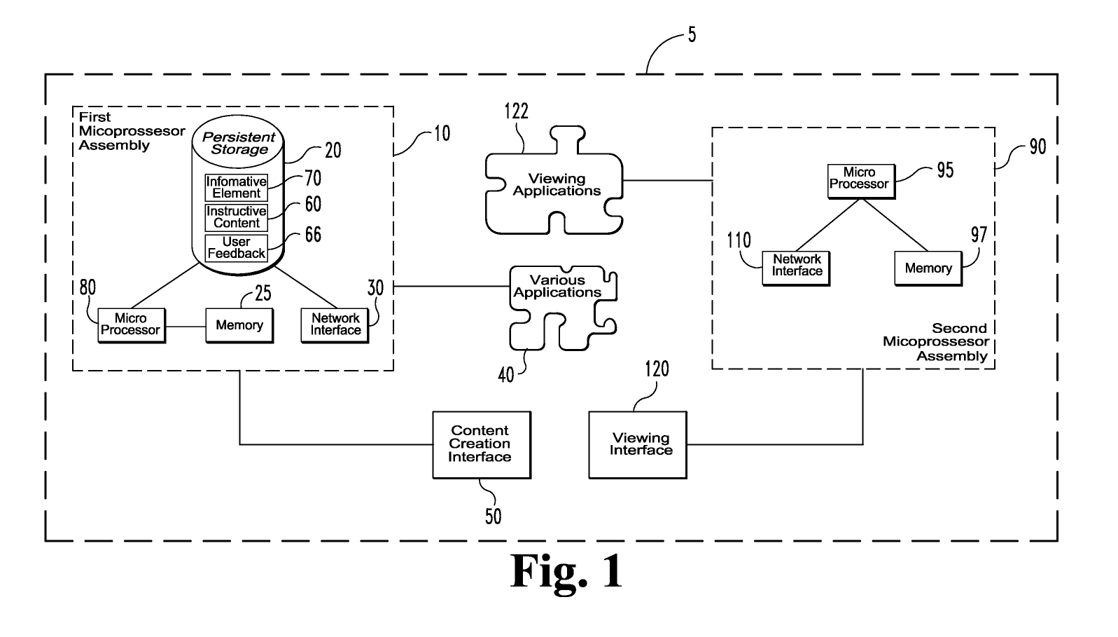

FIG. 1 presents an illustrated overview of a system 5 for retaining, managing, and interactively conveying knowledge and instructional according to a first embodiment of the present novel technology. The system 5 typically includes a first microprocessor assembly 10 having a persistent storage 20 and a first network interface 30 operationally connected thereto for use by an author or instructive content creator. The persistent storage 20 provides for the storing and retrieving of instructive content 60 and informative elements 70. Various applications 40 for instructive content 60 creation are operationally connected to the first microprocessor assembly 10 in that the first microprocessor assembly 10 serves to execute and host the various application 40. A content creation interface 50 is provided for using the applications 40 and is likewise operationally connected to first microprocessor assembly 10. The content creation interface 50 provides an organized view and means for the author to interact with the applications 40 when creating instructive content 60. The first microprocessor assembly 10 further includes a microprocessor 80 for housing and executing the various applications 40, the content creation interface 50, and is operationally connected to the persistent storage 20 and to a first memory 25.

Further, the system 5 typically also includes at least a viewing interface 120 and a second microprocessor assembly 90, which typically includes a second microprocessor 95, a second memory 97, and a second network interface 110. The second microprocessor 95 is operationally connected to the second memory 97, and to the second network interface 110. There is a viewing interface 120 that is operationally connected to the second microprocessor assembly 90 in that the viewing interface is executed upon the second microprocessor assembly 90. Various viewing applications 122 are likewise typically operationally connected to the second microprocessor assembly 90. A user interacts with and uses the viewing applications 122 through the viewing interface 120. It is instructive to understand that the viewing interface 120 provides a consistent view and means for a user to interact with the various viewing applications 122.

The author is charged with using the content creation interface 50 to create the instructive content 60. Through the content creation interface 50, the author typically interacts with various applications 40, either enhancing existing, or creating new, instructive content 60. When doing this, the author will typically access the persistent storage 20 to access existing instructive content 60, informative elements 70, and/or user feedback 66.

The user, desiring to view the instructive content 60, typically uses the viewing interface 120 to view instructive content 60. The user may also use the viewing interface 120 to personally annotate the instructive content 60, to send help requests to the author, and/or to submit user feedback 66.

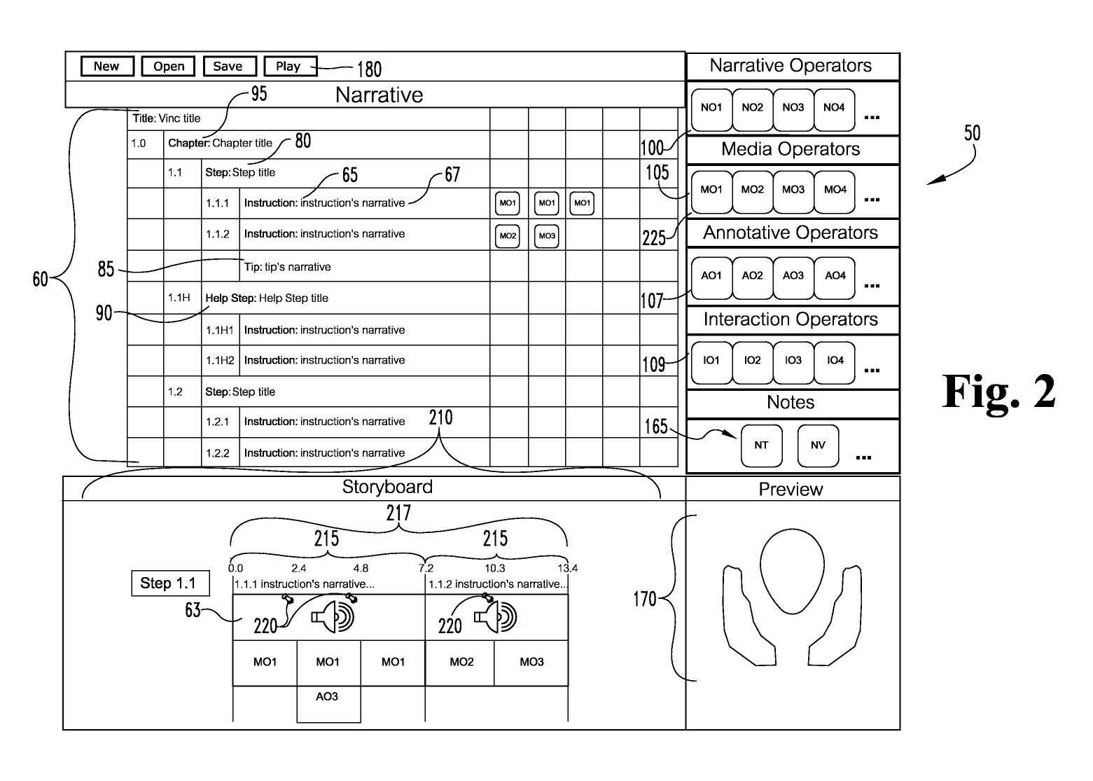

FIG. 2 presents an exemplary view of the content creation interface 50. Usually before any instructive content 60 can be experienced by the user, it must first have been created. An author may optionally first plan out the instructive content 60 before using the content creation interface 50. After planning out the instructive content 60, the author begins to use the content creation interface 50.

Typically, the author's first action is to begin by creating instructions 65 along with their corresponding narrative 67. One alternative is for the author to begin working with some already existing instructive content 60. The narrative 67 for an instruction 65 can be in any number of languages. An instruction 65 can also have more than one narrative 67, permitting multilingual instructions 65. It is instructive to note that in such a case, the user would decide which of the languages would be presented when viewing the instructive content 60. The user would make this selection through interaction with the viewing interface 120.

In addition to providing for future sub-titles, the narrative 67 is also converted into a computer generated speech file 63. The author may optionally also supply his own speech file 63. The content creation interface 50 uses the speech file 63, in producing an instruction relative timeline 215. A storyboard 210 is produced for an entire step 80. The durations of all the instructions' relative timelines 215 for instructions 65 of a step 80 together form the relative timeline 217 for the step's 80 storyboard 210.

Typically, the Informative elements 70 are composed of diverse, mixed media, such as pictures, video, audio, slide shows, and the like, but can also include other instructional content. There is typically no need for the author to understand the underlying complexities involved in forming a cohesive instruction 65. The author does not need to understand the underlying complexities because the content creation interface 50 performs the complex actions required to join the potentially diverse mixed informative elements 70 with the narrative 67.

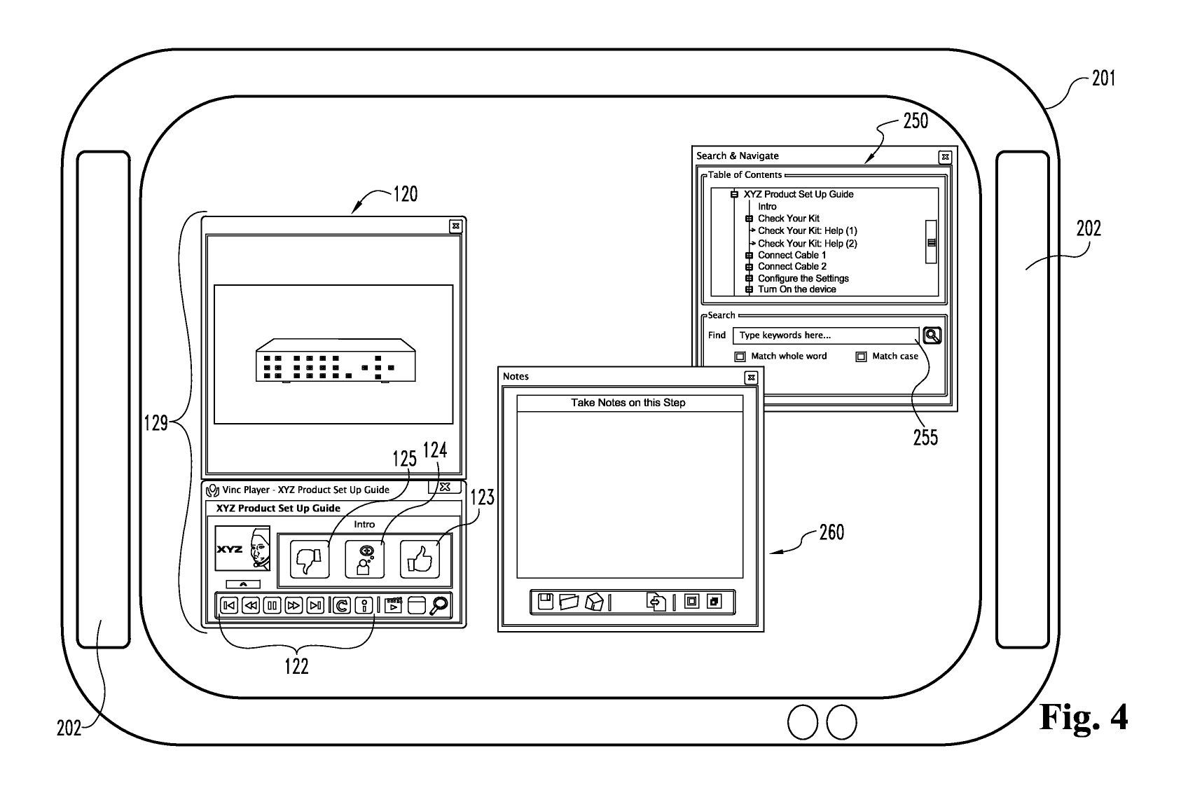

Typically the author will collect sets of instructions 65 forming steps 80. When viewed, a step 80 requires some form of response from the user. This in turn provokes an, “I understand and want to proceed” (as shown in FIG. 4) response 123 from the user when he has finished viewing that specific step 80. Other options the author may also provide include: “I'm unsure, give me a little assistance” 124 and “I do not understand, help me” 125. A chapter 95 is a collection of steps selected by the author as being loosely related to a common topic.

The content creation interface 50 has other elements which are depicted in the illustrated FIG. 2. The content creation interface 50 has a set of narrative operators 100 for modifying and structuring the narrative content. Typically, the interface also includes multimedia placeholders 225 and media operators 105 for manipulating the various multimedia based informative elements 70, annotation operators 107 for modifying annotative content, interaction operations 109 for modifying interactive content and instructive content note creation and manipulation operators 165. Similarly, the content creation interface 50 has a set of operations for collecting sets of instructions 65 to create steps 80. The content creation interface 50 has a set of operations for adding steps 80 and chapters 95 to instructive content 60. The content creation interface 50 also has a storyboard preview 170 area for previewing the entire step as it is at that time. In one embodiment, previewing a specific media is done by hovering a selector mouse over the respective icon of the media. The content creation interface 50 can also play 180 the instructive content 60 that is currently being developed.

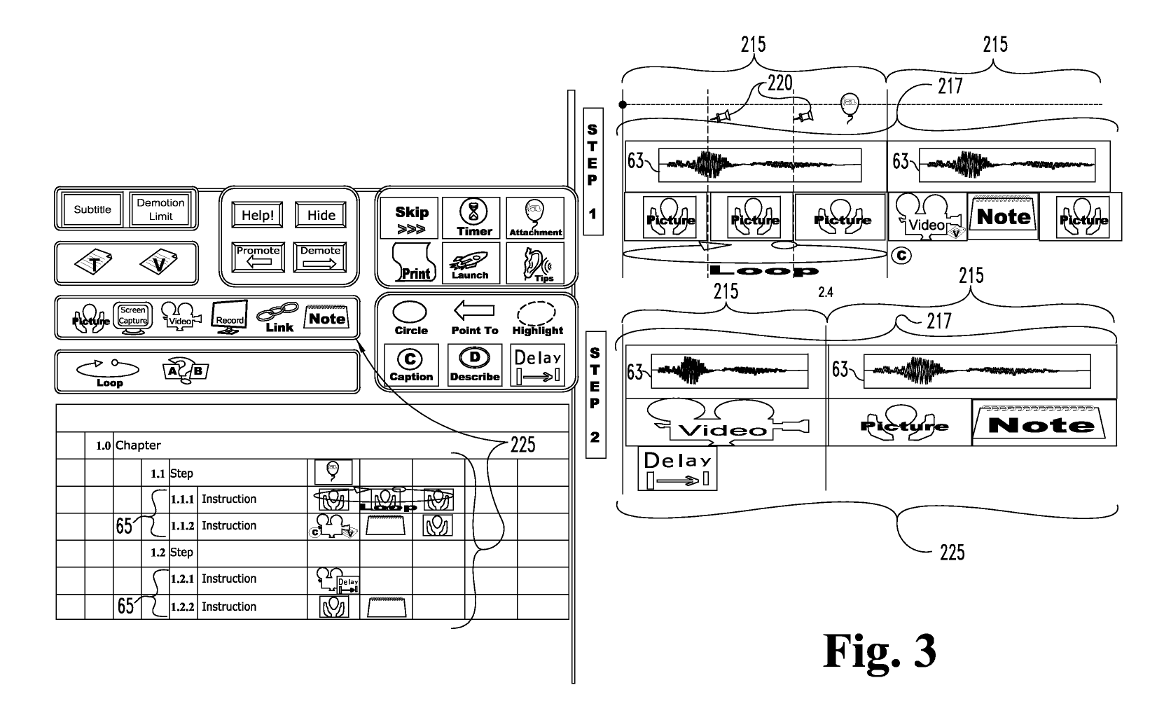

FIG. 3 presents a second exemplary view of the content creation interface 50 according to one example of the claimed technology. This figure serves to highlight the relationship between a step's 80 relative timeline 217 and the relative timeline 215 of an instruction 65.

Typically, the content creation interface 50 coherently joins the informative elements 70 associated with an instruction 65 in a best fit, equal basis manner against the relative timeline 215. Multimedia placeholders 225 are able to be dragged and dropped into a relative timeline 215. In this example, had there been three images chosen as informative elements 70 would each share one third (⅓) of the relative timeline associated with a given instruction 65 (as shown). To clarify, the author choosing to replace interface generated speech file 63 with an audio clip would not vary the positions and relative timings of the three images.

Further, repositioning the push pins 220 depicted in this example will vary the apportioned time associated with the respective images. In this example, moving the left most push pin 220 2.4 seconds to the right would produce a gap with nothing being displayed during presentation of the instructive content for the corresponding time associated with that produced gap. In the alternative, if the picture was bound to a pin, moving the pin one second to the right would increase the duration of the first picture by one second and decrease the duration of the second picture by one second.

FIG. 4 illustrates an exemplary display screen of instructive content presenting interface 120 according to still another example of the claimed technology. For the benefit of the viewer, this figure has been portrayed as representing one embodiment of this novel technology as displayed upon a computer monitor 201 with speakers 202.

Instructive content presenting interface 120 includes a portion 129 for viewing the viewable portions of instructive content 60, a set of controls for manipulating (fast forward, pause, reverse, etc.) 122 the viewing of the instructive content 60 and the user response buttons of “I understand and want to proceed” 123, “I'm unsure, give me a little assistance” 124, “I do not understand, help me” 125. Note that the “I understand and want to proceed” 123, “I'm unsure, give me a little assistance” 124, “I do not understand, help me” 125 buttons are context sensitive and are only active when appropriate. The “I understand and want to proceed” 123 button is typically used by the user to indicate that he understands the presented material. The “I'm unsure, give me a little assistance” 124, button is typically used when the user almost understands the concept and needs a hint to cement the concept in his mind. The “I do not understand, help me” 125 button is typically used when the user does not comprehend the material. The “I understand and want to proceed” 123, “I'm unsure, give me a little assistance” 124, “I do not understand, help me” 125 buttons are also respectively viewed as used to indicate some sort of positive response, some sort of less than positive response, and some sort of negative response from the user. Though not depicted in this figure, other context sensitive means of user interaction are possible. Examples include but are not limited to clickable links, file selection, launching applications, interactive panels, and the like.

Also shown is the optional table of contents 250 of the instructive content 60 and the optional note panel 260. The user is free to select any of the instructive content 60 for viewing from the table of contents 250. The user may also perform a key word search 255 to assist in selecting what portion of the instructive content 60 he desires to view. The note panel 260 is used to take notes that are associated with the specific portion of the instructive content 60 that is currently being viewed. Notes can take various forms including but not limited to text, voice, voice to text, multimedia, and the like. While mainly used for writing notes for the user, the user may also choose to send his notes to the instructive content author.

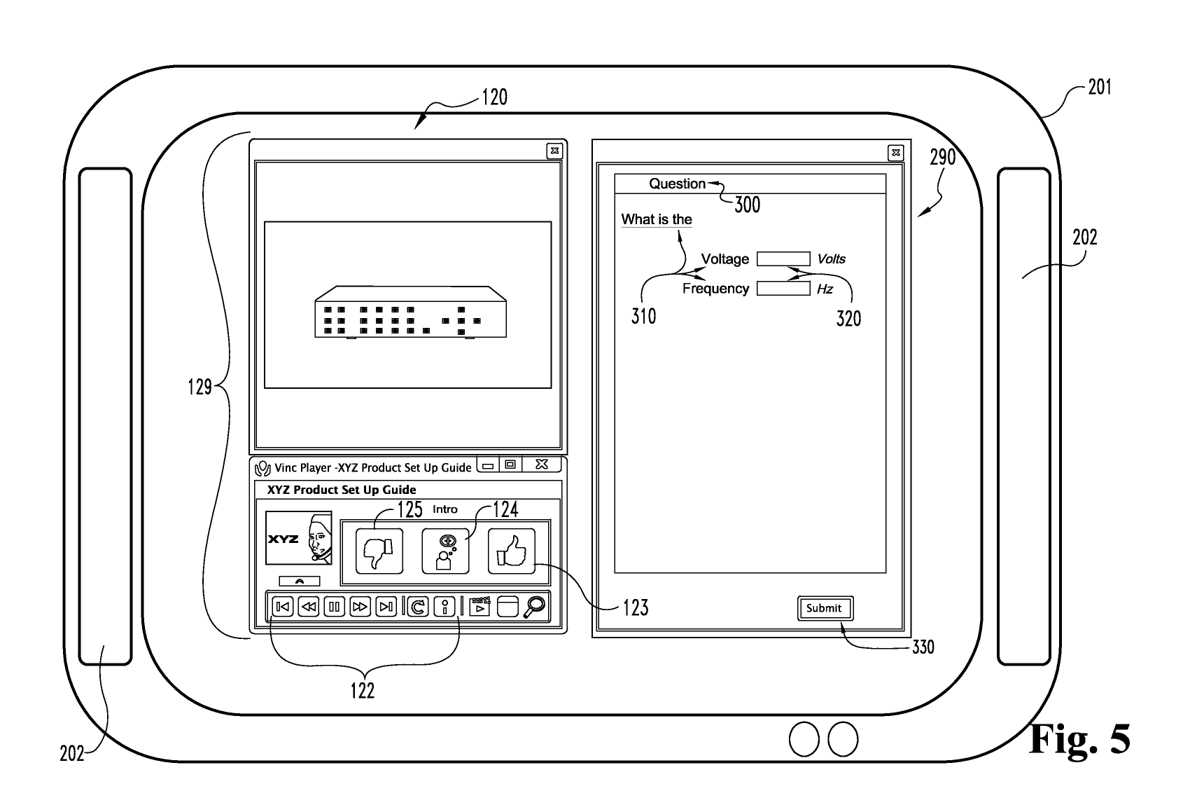

FIG. 5 illustrates an exemplary of an interactive panel 290 for interaction with a user according to still another example of the claimed technology. For the benefit of the viewer, this figure has been portrayed as representing one embodiment of this novel technology as displayed upon a computer monitor 201 with speakers 202. Similar to FIG. 4, this depiction shows the instructive content presenting interface 120 including a portion 129 for viewing the viewable portions of the instructive content 60, a set of controls for manipulating (fast forward, pause, reverse, etc.) 122 the viewing of the instructive content 60 and the user response buttons of “I understand and want to proceed” 123, “I need a hint” 124, “I do not understand, help me” 125. However this depiction also shows an interactive panel 290. Notice that the interactive panel 290 has a title 300, statement areas 310, user input areas 320, and a finished or submit button 330. Note that the number, format, and data type of the statement areas 310 and user input areas 320 can vary based upon context. In this example the interactive panel 290 is soliciting user supplied responses over the voltage and frequency of a power source. As such, the format and data type of the user input areas will be limited to appropriately ranged numeric values. If this example were allowed to continue, the instructive viewing interface 120 would utilize the user supplied information to present the portion of the instructive content 60 relevant to the entered voltage and frequency.

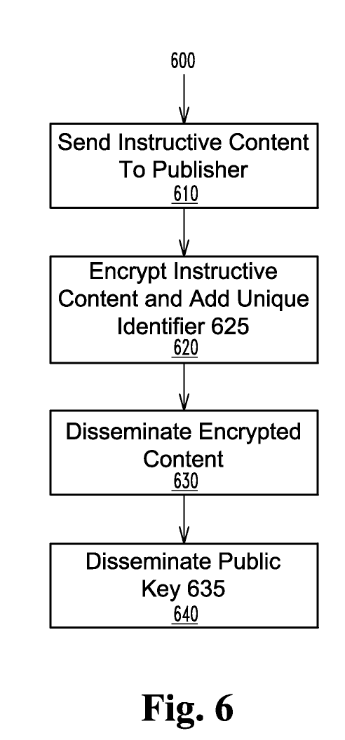

FIG. 6 is a process flow diagram 600 for one implementation illustrating the stages involved in publishing instructive content 60. The instructive content 60 is sent to the publisher, noted by process step 610. The instructive content 60 is typically encrypted, such as by using a public-private key encryption scheme as part of the publishing, as denoted by process step 620. The instructive content 60 also receives a unique identifier 625 as part of the public-private encryption process 620. The now-encrypted instructive content 60, is typically disseminated, denoted by process step 630. The public key 635 is also typically disseminated, denoted as process step 640.

As a nonlimiting example intended to help provide clarity to the reader, consider the problem of instructing someone how to change a toner cartridge in a specific brand and model laser printer. Verbally instructing someone over how to change a toner cartridge isn't a simple task, nor does it easily lend itself to reduction to text, pictures, or even video. Instead, the best way to instruct someone over how to change a toner cartridge is to actually demonstrate such a task in front of the student while explaining and pointing out additional pertinent information. It is instructive to note how there is a natural tendency to organize the entire demonstration around its narrative 67 content.

However, providing personalized instruction to every person who needs to learn how to change a toner cartridge is simply not feasible. Using this application's novel technology, what is feasible is to create and present instructive content 60 to every person who needs to learn how to change a toner cartridge. Furthermore, the instructive content 60 could have a SME's narrative 67 and organization along with contributions from others such as a multimedia specialist.

Note that this example includes more participants in the instructive content creation process than is minimally required. Under normal conditions, only one participant functioning as the author would create the example's content. Additionally, this example shows a linear creation process. However, there is no need for the creation to be linear. In practice, creation of instructive content 60 is typically an iterative process. To start, the author would open a new instructive content project. The author would then assign various subsets of rights to the members of his team. In this example, the author's team consists of himself, a SME, and a multimedia specialist. He would probably maintain all rights while limiting the SME's rights and privileges to those required for producing a narrative 67 and organizing the content. The author would probably grant the multimedia specialist very limited rights because of his limited role.

The SME, in this example, would probably start by creating several instructions 65 through usage of the content creation interface 50. Note that each instruction 65 typically has a narrative 67 associated with it. Narrative 67 is as it sounds, it is the typed text of the spoken component of the instruction 65. The content creation interface 50 then usually produces a text to speech file 63 for each instruction 65. The audio text to speech file 63 is then used to create an organizational timeline for each instruction 65.

It is important to note that the timeline, being relative to each instruction 65 and based upon the narrative 67, permits easy organization of the presentation media. When an expert explains something to someone, the expert organizes the presentation around his statements. For example, an expert as part of his presentation might present a picture congruent to his current topic. He will only present that picture as long as it is applicable. In much the same way, any multimedia elements used in the instructions 65 are indexed and organized against the timeline of the associated instruction 65.

Wishing to add multimedia elements to the narrative 67, the SME first selects an instruction 65. He then selects the appropriate multimedia placeholders and places them into that instruction's 65 timeline. Alternatively, the multimedia placeholders can also be placed into an instruction's 65 timeline through the use of hot keys, the use of an instruction template, cloning of an existing instruction 65, and the like. Thus, the placement of a multimedia placeholder into an instruction's 65 timeline can be done before, during, or after the adding of narrative 67 to the instruction 65. Inserting the multimedia placeholders during the narration of an instruction 65 has an additional benefit. Doing so automatically indexes the multimedia relative to the end of the narration already entered for that that instruction 65.

A multimedia placeholder is best thought of as serving two functions. First, it tells the content creation interface 50 what type of multimedia will be associated with the instruction 65. Second, it can be used to denote what portion of the instruction's 65 timeline will be allocated to that multimedia. For example, the SME could determine that he wants only five seconds of a twelve second timeline given to an image. Of course, audio and video typically will impose additional constraints. This is because the video and audio are generally, though not always, played in entirety. As such, typically only the start or stop of the audio and/or video, but not both, can be indicated.

At some point, the SME is likely to want to start to collect instructions 65, forming steps 80. A step 80 is a collection of logically related instructions 65 that are best presented together. A good analogy would be if the SME was teaching another, his sentences equate to instructions 65 while his paragraphs equate to steps 80. It is instructive to note that while the instruction 65 presents a linear instructive content development process, no such limitation is imposed upon the act of authoring. In fact in practice, many developmental test authors have found iterating among the various development processes to be their preferred means of creating new instructive content. Having steps 80, the SME will then determine what subsets of the steps require additional content. When played on the viewing interface, each step 80 usually ends with the user having to give a response. The normal default responses are; “I understand,” “I need a hint,” “I need more help.” However, in practice only a subset of the steps are likely to require additional content to make up a hint or to provide additional help. The SME selects which steps 80 he believes will require such additional content. The additional content can come from existing instructions 65, steps 80, or even other instructional content 60. In practice, a hint is satisfied by one or more instructions 65 while help requires steps 80 or other instructional content 60.

The additional instructive content 60 included as either help or a hint is available at the end of a step 80. It is informative to note that a hint is circular in that after receiving the additional information, the user ends up back to where he requested the hint from. On the other hand, help has the two possible exit points of either at the beginning of the next instruction 65 or the exit of current topic. This is because if the help is successful, then the user is ready to continue on. If the help is not successful, then the user needs additional assistance and should request such assistance. In this way, the additional content actually serves to provide the hint or help while not confusing or losing the user.

This is unlike the steps 80 associated with an interactive panel. While those steps 80 typically deal with a common topic, the SME believes they are best presented in a sequence determined through the actions of the user. For example, an interactive panel can be used to determine how much a user already understands about a topic. The interactive panel would show only the steps 80 over information that the user doesn't have.

The SME would then usually organize the steps 80 into chapters 95. As previously noted, this example presents a linear sequence when the content creation interface 50 imposes no such limitation. A chapter 95 is composed of steps 80 loosely related to a common though more generic topic. A table of contents is also created, listing the chapters 95 and steps 80. Later during viewing, a user can choose to jump to a chapter 95 or a specific step 80 within a chapter 95 that he is most interested in rather than other possible starting points.

At some point, the SME would desire to turn over some portion of the instructive content 60 to the multimedia specialist or perhaps even a team of multimedia specialists. Alternatively, the multimedia specialist and the SME could be working in parallel or iteratively on the instructive content. Continuing with the example, it would be the multimedia specialist's job to select the images, audio clips, attachments, audio-visual clips, applications, and the like for use in the instructive content. As previously noted, the SME has already decided where and when the various multimedia elements should be within the instructive content 60 though placing the appropriate multimedia placeholders. The multimedia specialist would replace the multimedia placeholders with the desired content by simply dragging and dropping the multimedia representative icon, file descriptor, URL, or the like over the placeholder.

The author typically submits the instructive content 60 once it is finished. As previously stated, publishing the instructive content 60 is under the control of a central authority. Publishing also adds a unique identifier and encrypts the instructive content. The act of publishing accomplishes three valuable functions. First, it provides protection against unauthorized alterations or counterfeit instructive content. In this way, the user can be sure that he is viewing authorized and only authorized content.

Second, the combination of a central authority serving as the publisher in conjunction with a unique identifier provides a natural version control. The rapid pace of technological innovation often means that there is a proliferation of out of date manuals and other sources of information. This technology solves that problem by a single publisher serving to publish and push out the instructive content.

Finally, the publishing process provides strong control over the intellectual property within the instructive content. The encryption prevents the unauthorized copying of the content. Additionally, unauthorized viewing is prevented since decryption of the instructive content 60 cannot occur without the appropriate decryption key.

Continuing the example from the user's viewpoint, assume the user has never changed the toner cartridge in his printer. He uses a delivery device, perhaps his smart cell phone, and downloads or accesses the appropriate instructive content. He knows he can trust that the instructive content 60 is up to date and legitimate due to the publishing process. The user then starts the presentation of the instructive content 60 on his chosen delivery device.

It is instructive to understand that the act of downloading the appropriate instructive content 60 is appropriate within the context of the example but not necessary. A user does not need connectivity to the Internet or even a network. The instructive content 60 could be delivered upon the delivery device in many different ways. In addition to some sort of network connectivity, the instructive content 60 could also be delivered to the delivery device through DVD, CD, floppy disk, USB key, and the like. This enables instructive content 60 to be utilized in non-connectivity to the Internet situations. A nearly perfect illustration of such a situation is when the user is viewing instructive content 60 on how to connect to the Internet.

The SME, knowing how frustrating it can be to have to search for the particular model's instruction 65, has provided an interactive panel to help guide the user. The user enters in his printer model's number. The interactive panel presents the user with the content appropriate for his printer.

The SME has provided for another interactive panel to help the user diagnose the problem. The viewing interface, running on the chosen delivery device, presents the interactive panel, perhaps this time consisting of a collection of questions. The user enters in his problem of his print jobs being too light. Another interactive panel then displays containing a collection of possible causes (topics) of his problem.

The user knows that he needs to replace the toner cartridge. He selects, out of the interactive panel, the topic pertaining to replacing the toner cartridge. The view starts to display this topic. In this example, assume that the first step 80 is to make sure that he has the appropriate replacement cartridge. If the user isn't sure that he has the appropriate replacement cartridge, he can ask for a hint. For the sake of this example, assume that the hint is sufficient and the user is ready to replace the cartridge.

The user places his smart cell phone on top of his printer so that he can have both hands free. He verbally instructs the viewing interface 120 to continue. The next series of instructions 65 tells him to open the access and press a lever to release the cartridge. There is also a small video demonstrating such. While watching the demonstrating video, hands within his printer, his four year old son chases the family cat into the same room and general chaos erupts. Desiring the save the family pet from the tyrannical clutches of four year old son, he tells the viewing interface 120 to pause, he removes his hands from within his printer, and he scoops up his child while the cat darts out of the room to hide somewhere.

Eventually, the user comes back to the task at hand. Not quite remembering where he was, the user rewinds part of the instructive content. He catches up to where he was continues from where he left off. He adds a personal note to the instructive content 60 that the next time to make sure that his child is occupied before servicing the printer. The next instruction 65 states how there will be a distinctive snap when the replacement cartridge is properly seated within the printer. The viewing interface 120 plays a sound clip of the distinctive snap. Following the presented instructions 65, the user replaces the toner cartridge while listening for the distinctive snap. He hears the distinctive snap and has successfully replaced the toner cartridge of the printer.

The user is happy and gives high praise when answering the improvement survey at the end of the presentation. However, the user does comment that the author might consider adding an additional topic over how to keep one's small child occupied while performing printer maintenance. At a later time, the author reviews the collected responses of many surveys for the purpose of improving the instructive content. While a good suggestion, the author finally decides that the child care is a little bit too off topic for this instructive content.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A system to electronically create and publish instructive content for subsequent presentation utilizing an electronic viewing apparatus, comprising:
a programmed application set, further comprising:
a content creation interface; and
a timeline creation portion;
wherein the programmed application set is configured to execute on a first microprocessor assembly including:
a first microprocessor;
a first memory operationally connected to the first microprocessor;
a first network interface operationally connected to the first microprocessor; and
a first persistent storage portion operationally connected to the first microprocessor;
wherein upon execution, the programmed application set is operationally connected to the first persistent storage portion;
wherein upon execution of the programmed application set, the content creation interface is operationally connected to the first microprocessor;
wherein the programmed application set is author accessible through the content creation interface;
wherein a respective timeline may be created for each instruction;
wherein an author may associate multimedia elements with instructions through interactions with the content creation interface;
wherein the author may assign chronological relationships between the instruction-associated multimedia elements as measured against the respective timeline;
wherein instructional content may be generated by the organization of the instructions and the instruction-associated multimedia elements; and
wherein the instructive content may be published.

2. The system of claim 1 wherein the published instructive content contains the encrypted instructive content.

3. The system of claim 1 wherein the published instructive content is first decrypted through the use of a public key before viewing.

4. The system of claim 1 wherein a portion of the programmed application set includes permits the author to embed multimedia element placeholders, multimedia elements, and descriptive information into the instructive content.

5. The system of claim 1 wherein the published instructive content contains a unique identifier.

6. The system of claim 1 wherein the timeline creation portion of the programmed application set may utilize criteria for creating respective timelines for each respective instruction, said criteria selected from the set including; narrative, multimedia element placeholders, multimedia elements, and combinations thereof in creating respective timelines for each instruction.

7. The system of claim 1 wherein a portion of the programmed application set permits the author to form steps of instructions.

8. The system of claim 1 wherein a portion of the programmed application set permits the author to associate instructions with an interactive panel.

9. The system of claim 1 wherein a portion of the programmed application set permits the author to augment subsets of steps with additional instructive content.

10. The system of claim 1 wherein a portion of the programmed application set permits the author to arrange instructive content through the organizing of instructions, steps, and other instructive content.

11. A method for electronically organizing and providing instructive content created by an author for presentation to a user in an interactive, context-sensitive and user-directed manner comprising:
a. receiving instructions with narrative content from an author;
b. automatically creating a narrative-based timeline for organizing multimedia elements;
c. receiving at least one multimedia element;
d. assigning the at least one multimedia element to a position on the timeline;
e. receiving finalized instructive content from the author for publishing;
f. providing published instructive content to a delivery device, wherein the delivery device includes;
a microprocessor,
a memory operationally connected to the microprocessor, and
a viewing interface operationally connected to the microprocessor; and
g. reorganizing the display of multimedia elements of the published instructive content to define a revised timeline.

12. The method of claim 11 wherein actuating the viewing interface permits a user to review the instructive content.

13. The method of claim 11 wherein actuating the viewing interface permits a user to guide with the instructive content.

14. The method of claim 11 wherein actuating the viewing interface permits a user to interact with the instructive content.

15. The method of claim 11 wherein actuating the viewing interface permits a user to provide feedback.

16. The method of claim 11 wherein multiple authors can serve as the source for the instructive content.

17. The method according to claim 11, further comprising the steps of:
h. after (f) and before (g), automatically revising the timeline based upon user selected narrative.

18. The method of claim 11 wherein the viewing interface includes features which facilitate presentation of published instructive content to users having visual, hearing, or other sensory or learning impairments.

19. The method of claim 11 wherein the published instructive content includes;
a unique identifier; and
encryption such that a provided public key can decrypt the instructive content; and
sourcing from a single entity.

20. The method of claim 11 wherein the author may embed multimedia placeholders, multimedia, and descriptive information into instructions.

21. The method of claim 11 wherein the narrative-based timeline is based upon narrative of instructions, multimedia placeholders, multimedia, and descriptive information.

22. The method of claim 11 wherein the published instructive content may include interactive panels.

23. The method of claim 11 wherein the received instructions may be further organized into steps.

24. The method of claim 11 wherein the received instructions may be further organized into chapters.

25. The method of claim 11 wherein subsets of the steps may be augmented with additional instructive content.
